(19) United States
(12) Patent Application Publication
(10) Pub. No.: US 2014/0010970 A1
(43) Pub. Date: Jan. 9, 2014

(54) PHOTOCURABLE POLYETHYLENE GLYCOL SILSESQUIOXANE, POLYETHYLENE GLYCOL SILSESQUIOXANE NETWORK PREPARED THEREFROM, ANTI-BIOFOULING DEVICE INCLUDING THE POLYETHYLENE GLYCOL SILSESQUIOXANE NETWORK, AND METHOD OF PREPARING NANO-PATTERN

(71) Applicant: Electronics and Telecommunications Research Institute, Daejeon (KR)

(72) Inventor: Bong Kuk LEE, Daejeon (KR)

(21) Appl. No.: 13/929,364

(22) Filed: Jun. 27, 2013

(30) Foreign Application Priority Data
Jul. 3, 2012 (KR) 10-2012-0072474

(51) Int. Cl. C09D 5/16

(52) U.S. Cl. CPC C09D 5/1637
USPC 427/510; 528/32; 522/99

(57) ABSTRACT

The present invention relates to a photocurable polyethylene glycol silsesquioxane, a polyethylene glycol silsesquioxane network prepared therefrom, an anti-biofouling device including the polyethylene glycol silsesquioxane network, and a method of preparing a nanopattern. The polyethylene glycol silsesquioxane network has a high anti-biofouling property, low viscosity, high optical transparency, good hydrophilicity, high resistance to swelling in organic solvents/aqueous solutions, high stability under biological, chemical, and thermal stress, and high mechanical strength, and can be useful in a wide range of biomedical devices because it enables the manufacture of micro-nanopatterns.

### CROSS-REFERENCE TO RELATED APPLICATION

This application claims priority to and the benefit of Korean Patent Application No, 10-2012-0072474 filed in the Korean Intellectual Property Office on Jul. 3, 2012, the entire contents of which are incorporated herein by reference.

### BACKGROUND OF THE INVENTION

1. Field of the Invention

The present invention relates to a photocurable polyethylene glycol silsesquioxane, a polyethylene glycol silsesquioxane network prepared therefrom, an anti-biofouling device including the polyethylene glycol silsesquioxane network, and a method of preparing a nanopattern. More particularly, the present invention relates to a photocurable polyethylene glycol silsesquioxane, which is highly resistant to non-specific adsorption of proteins or the like and can be directly nanopatterned, a polyethylene glycol silsesquioxane network prepared therefrom, an anti-biofouling device including the polyethylene glycol silsesquioxane network, and a method of preparing a nanopattern.

2. Description of the Related Art

Avoiding non-specific adsorption of biopolymers (proteins, DNA, cells, etc.) on solid surfaces is crucial in the manufacture of biomedical devices, biosensors, diagnostic arrays, implants, and drug delivery systems (Senaratne W. et al, Biomacromolecules, 6: 2427, 2005; Cooper S. L. et al Biomaterials: Interfacial phenomena and applications, 1982).

The problem of nonspecific adsorption can be avoided by precoating surfaces with a material that is resistant to biomolecular adsorption. A variety of polymer materials such as polyvinyl alcohol), polyethylene glycol) (PEG), poly(acrylamide), dextran, and methacrylated phosphatidylcholine have been used as coating materials to prevent or minimize non-specific adsorption (Amanda A, et al., Mallapragada, Biotechnol. Prog., 17: 917, 2001; Harris J. M. et al., Poly(ethylene glycol) chemistry. Biotechnical and Biomedical Applications, 1992; Park S. et al., J. Biomed. Mater. Res. 53: 568, 2000; Masson J. F. et al., Talanta, 67: 918, 2005; Ishihara K., Sci. Technol. Adv. Mater. 1: 131, 2000).

These coating materials have been modified to form self-assembled monolayers (SAMs), polymer brushes, and hydrogels, and have been attached to solid surfaces by physical adsorption and covalent immobilization using techniques such as chemical coupling (Amanda A. et al., Mallapragada, Biotechnol. Prog., 17: 917, 2001; Harris J. M. et al., Poly(ethylene glycol) chemistry. Biotechnical and Biomedical Applications, 1992; Park S. et al., J. Biomed. Mater. Res., 53: 568, 2000, Masson J. F. et al., Talanta, 67: 918, 2005; Ishihara. K., Sci, Technol. Adv. Mater., 1: 131, 2000; Dulcey C. S. et al., Science, 252: 551, 1991; Milner S. T Science, 251:905, 1991; Spargo B. J. et al., Proc. Natl. Acad. Sci. U.S.A., 91: 11, 070, 1994; Ruhe J. et al., J. Biomater. Sci., Polym. Ed., 10: 859, 1999; Ratner B. D. et al., Annu. Rev. Biomed, Eng., 6: 41, 2004; Sibarani J. et al., Colloids Surf., B, 54: 88, 2007). Furthermore, these materials with micro/nanoscale features can be directly or indirectly patterned to integrate miniaturized biomedical devices and biosensors on solid substrates using various lithographic techniques, including deep ultraviolet lithography (Duicey C. S. et al., Science, 252: 551, 1991), standard photolithography (Revzin A et al., Langmuir, 19: 9855, 2003), dip-pen lithography (Lee K. B. et al., Nano Lett., 4: 1869, 2004), electron beam lithography (Smith J C. et al., Nano Lett 883, 2003), soft lithography (Whitesides G. M. et al., Annu. Rev, Biomed. Eng., 3: 335, 2001; Mendes P. M et al. Nanoscale Res. Lett., 2: 373, 2007), and nanoimprint lithography (Falconnet D. et al., Nano Lett., 4: 1909, 2004; Lee B. K. et al., Small, 4: 342, 2008; Lee B. K et al., Lab Chip, 9: 132, 2009).

Precoating a solid surface with an anti-biofouling SAM, polymer brush, or hydrogel is a well-established method to prevent nonspecific adsorption of biomolecules; however, these coatings may have disadvantages in terms of the long-term stability of the material. It has been reported that PEG-based SAMs are unstable and auto-oxidize rapidly, especially in the presence of oxygen and transition metal ions (Ostuni et al., Langmuir, 17: 5605, 2001; Chen S. et al., J. Am. Chem. Soc., 127: 14, 473, 2005; Crouzet C. et al., Makromol. Chem., 177: 145, 1976), and that grafted EG brushes gradually lose their protein repulsive properties above 35° C. (Leckband D. et al., J. Biomater, Sei Polym. Ed., 10: 1125, 1999). The PEG hydrogels are too brittle in aqueous solutions (Priola A. et al., Polymer, 34: 3653, 1993), and their 3-0 structures collapse into small pieces due to the significant swelling that occurs in aqueous solutions (Kim P. et al., Lab Chip, 6: 1432, 2006).

These previous studies indicate that a stable, anti-biofouling material is needed for the production of biomedical devices, biosensors, and labs-on-a-chip because the instabilities of anti-biofouling materials are directly related to their accuracy, sensitivity, and reproducibility in biosensing.

To produce these devices, stable, ant biofouling materials need to be incorporated into nanostructures using appropriate patterning methods with high throughput, low cost, and high reproducibility. In simplifying patterning processes; the use of direct patterning of anti-biofouling materials is more efficient than indirect patterning (Revzin A et al., Langmuir, 19: 9855, 2003; Lee B. K. et al., Small, 4: 342, 2008; Lee B. K. et al., Lab Chip, 9: 132, 2009; Kim P. et al., Adv. Mater., 20: 31, 2008), Sufficiently rigid materials with tensile moduli greater than 100 MPa are required to replicate patterns reproducibly without collapse of the features at the sub-50-nm scale (Palmieri F. et al., ACS Nano, 1: 307, 2007).

From this viewpoint, the desirable properties of an ideal anti-biofouling material for advanced performance in a wide range of biomedical applications include a high anti-biofouling property (Revzin A et al., Langmuir, 19: 9855, 2003; Lee B. K et al., Small, 4: 342, 2008; Lee B. K. et al., Lab Chip, 9: 132, 2009; Kim P. et al., Adv. Mater., 20: 31, 2008); low viscosity; high optical transparency; good hydrophilicity (Jeong H. E. et al., Small, 3: 778, 2007); high resistance to swelling in organic/aqueous solutions (Kim P. et al., Lab Chip, 6: 1432, 2006); high stability under biological, chemical, and thermal stress; high mechanical strength; and direct patternability.

Anti-boifouling materials that satisfy all of these charac eristics however, have not yet been reported.

### SUMMARY OF THE INVENTION

The present invention has been made in an effort to provide a photocurable polyethylene glycol silsesquioxane, which is used as a material for anti-biofouling devices.

Another aspect of the present invention is to provide a polyethylene glycol silsesquioxane network prepared from the photocurable polyethylene glycol silsesquioxane.

Yet another aspect of the present invention is to provide an anti-biofouling device including the polyethylene glycol silsesquioxane network.

A further aspect of the present invention is to provide a method of preparing a nanopattern using the polyethylene glycol silsesquioxane network.

An exemplary embodiment of the present invention provides a photocurable polyethylene glycol silsesquioxane (PEG-SSQA) represented by the following Formula 3:

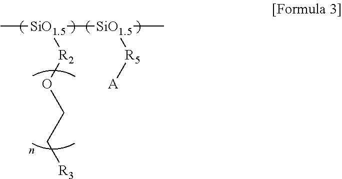

wherein,

R2 is one selected from the group consisting of a simple bond, a urethane bond, and an alkylene group with 1 to 10 carbons;

R3 is a hydroxyl group or an alkoxy group with 1 to 10 carbons;

R5 is one selected from the group consisting of a simple bond, a urethane bond, and an alkylene group with 1 to 10 carbons;

A is one photocurable functional group selected from the group consisting of an acrylate group, a methacrylate group, a glycidyl ether group, an oxetane group, an epoxy cyclohexane group, and a vinyl ether group; and

n is an integer of from 4 to 10.

Another exemplary embodiment of the present invention provides a polyethylene glycol silsesquioxane network which is prepared by mixing a photoinitiator with the photocurable polyethylene glycol silsesquioxane and curing the mixture by UV irradiation.

Yet another exemplary embodiment of the present invention provides an anti-biofouling device including the polyethylene glycol silsesquioxane network.

A further exemplary embodiment of the present invention provides a method of preparing a nanopattern, the method including: forming a photocurable polyethylene glycol silsesquioxane represented by the following Formula 3 by mixing a compound represented by the following Formula 1 with a compound represented by the following Formula 2; coating a composition including the photocurable polyethylene glycol silsesquioxane and a photoinitiator onto a substrate; and irradiating UV light to the coated composition to cure and nanopattern the photocurable polyethylene glycol silsesquioxane:

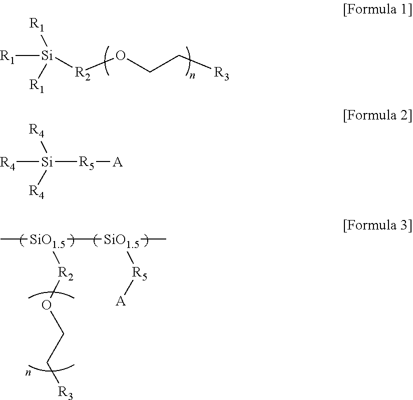

wherein,

R1 is an alkoxy group with ito 10 carbons or a halogen atom;

R2 is one selected from the group consisting of a simple bond, a urethane bond, and an alkylene group with 1 to 10 carbons;

R3 is a hydroxyl group or an alkoxy group with 1 to 10 carbons;

R4 is an alkoxy group with 1 to 10 carbons or a halogen atom;

R5 is one selected from the group consisting of a simple bond, a urethane bond, and an alkylene group with 1 to 10 carbons;

A is one photocurable functional group selected from the group consisting of an acrylate group, a methacrylate group, a glycidyl ether group, an oxetane group, an epoxy cyclohexane group, and a vinyl ether group; and

n is an integer of from 4 to 10.

### BRIEF DESCRIPTION OF THE DRAWINGS

FIG. 1 is a photograph of a polyethylene glycol silsesquioxane obtained in accordance with Example 1.

FIG. 2 shows NMR spectra of the polyethylene glycol silsesquioxane obtained in accordance with Example 1.

FIG. 3 schematically shows a method of preparing a nanopattern in accordance with Example 3.

FIG. 4 shows a scanning electron micrograph of the nanopattern and master mold in accordance with Example 3.

FIG. 5 is a graph showing changes in water contact angle over time of the polyethylene glycol silsesquioxane of Example 2.

FIG. 6 is a graph showing the transmittance versus wavelength of the polyethylene glycol silsesquioxane network of Example 2 and quartz.

FIG. 7 is a graph showing the Young's modulus of the polyethylene glycol silsesquioxane network of Example 2.

FIG. 8 shows AFM images of a polyethylene glycol silsesquioxane network pattern of Example 2 and a mold.

FIG. 9 is a photograph showing fluorescence images of glass and the polyethylene glycol silsesquioxane network of Example 2

FIG. 10 is a graph showing the measurements of the fluorescence intensity of BSA-FITC and EGFP on the surfaces of glass and the polyethylene glycol silsesquioxane network of Example 2.

### DETAILED DESCRIPTION OF THE EMBODIMENTS

While such terms as “first,” “second,” etc., may be used to describe various components, such components must not be limited to the above terms. The above terms are used only to distinguish one component from another.

The terms used in the present specification are merely used to describe particular embodiments, and are not intended to limit the present invention. An expression used in the singular encompasses an expression of the plural, unless it has a clearly different meaning in the context. In the present specification, it is to be understood that the terms such as “including,” “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

It will also be understood that when a layer or element is referred to as being “on” or “onto” another layer or substrate, it can be directly on the other layer, element, or substrate, or intervening layers or elements may also be present.

The present invention may be modified in various ways and may have several embodiments. Specific embodiments of the present invention are illustrated in the drawings and described in detail in the detailed description. However, the present invention is not intended to be limited to the specific embodiments, and it should be understood that the present invention includes all modifications, equivalents, or substitutions which fall within the spirit and technical scope of the present invention

Hereinafter, the present invention will be described in detail.

In accordance with one aspect of the present invention, there is provided a photocurable polyethylene glycol silsesquioxane represented by the following Formula 3:

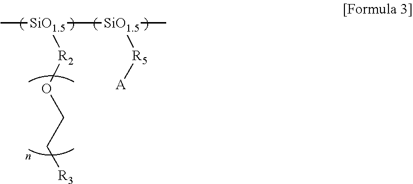

wherein,

R2 is one selected from the group consisting of a simple bond, a urethane bond, and an alkylene group with 1 to 10 carbons;

R3 is a hydroxyl group or an alkoxy group with 1 to 10 carbons;

R5 is one selected from the group consisting of a simple bond, a urethane bond, and an alkylene group with 1 to 10 carbons;

A is one photocurable functional group selected from the group consisting of an acrylate group, a methacrylate group, a glycidyl ether group, an oxetane group, an epoxy cyclohexane group, and a vinyl ether group; and

n is an integer of from 4 to 10.

In accordance with one exemplary embodiment of the present invention, in the above Formula 3, R2 may be an alkylene group with 1 to 6 carbons, R3 may be an alkoxy group with 1 to 3 carbons, R5 may be an alkylene group with 1 to 6 carbons, and A may be an acrylate group.

The photocurable polyethylene glycol silsesquioxane represented by Formula 3 may be prepared by the hydrolytic condensation of a compound represented by the following Formula 1 and a compound represented by the following Formula 2.

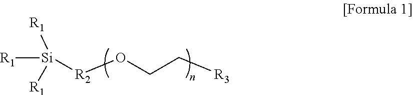

wherein,

R1 is an alkoxy group with 1 to 10 carbons or a halogen atom; R2 is one selected from the group consisting of a simple bond, a urethane bond, and an alkylene group with 1 to 10 carbons; R3 is a hydroxyl group or an alkoxy group with 1 to 10 carbons; and

n is an integer of from 4 to 10.

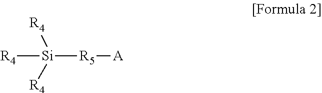

wherein,

R4 is an alkoxy group with 1 to 10 carbons or an halogen atom; R5 is one selected from the group consisting of a simple bond, a urethane bond, and an alkylene group with 1 to 10 carbons; and A is one photocurable functional group selected from the group consisting of an acrylate group, a methacrylate group, a glycidyl ether group, an oxetane group, an epoxy cyclohexane group, and a vinyl ether group;

The mixing ratio of the compound represented by Formula 1 to the compound represented by Formula 2 may be in the range of, but is not specifically limited to, 1:20 to 20:1 in a weight ratio.

In accordance with one exemplary embodiment of the present invention, the reaction between the compound represented by Formula 1 and the compound represented by Formula 2 may be performed by using a base CsOH, MeN₄OH, or KOH as a catalyst.

In accordance with one exemplary embodiment of the present invention, in the above Formula 1, R1 may be an alkoxy group with 1 to 3 carbons, R2 may be an alkylene group with 1 to 6 carbons, and R3 may be an alkoxy group with 1 to 3 carbons, and in the above Formula 2. R4 may be an alkoxy group with 1 to 3 carbons, R5 may be an alkylene group with 1 to 6 carbons, and A may be an acrylate group.

For example, the compound of Formula 1 may be polyethylene glycol trimethoxysilane of the following structural formula.

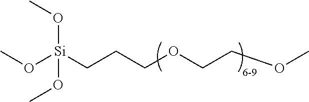

The compound of Formula 2 may be 3-(acryloyloxy)propyl trimethoxysilane of the following structural formula.

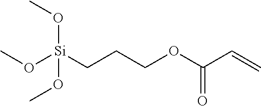

The compound represented by Formula 1 and the compound represented by Formula 2 form a photocurable polyethylene glycol silsesquioxane represented by the following Formula 3 by hydrolytic condensation.

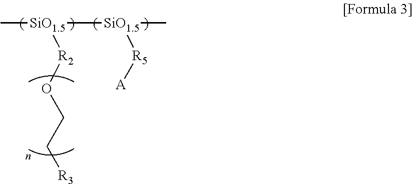

A weight average molecular weight of the polyethylene glycol silsesquioxane represented by Formula 3 may range from about 1500 to about 8000.

In another aspect of the present invention, there is provided a polyethylene glycol silsesquioxane network which is prepared by mixing a photoinitiator with the photocurable polyethylene glycol silsesquioxane and curing the mixture by UV irradiation.

The photoinitiator may be, but is not limited to, one selected from the group consisting of OMPA (2,2′-dimethoxy-2-phenylacetophenone), HMPP (2-hydroxy-2-methyl-1-phenyl-propane-1-one), 2,4,6-trimethylbenzoyl-diphenylphosphine oxide, and diphenyl trimethylbenzoyl phosphine oxide.

The polyethylene glycol silsesquioxane network is a kind of cross-linked polymer which is formed by cross-linking the photocurable functional group A of the photocurable polyethylene glycol silsesquioxane with an adjacent photocurable functional group A.

In accordance with one exemplary embodiment of the present invention, the polyethylene glycol silsesquioxane network may include at least one photocurable monomer, in addition to the photocurable polyethylene glycol silsesquioxane and the photoinitiator. The photocurable monomer may include monofunctional, bifunctional, trifunctional, and polyfunctional monomers capable of radical polymerization or anionic polymerization.

The photocurable monomer may further include additives such as an ultraviolet absorbing agent, an ultraviolet light stabilizer, an antioxidant, a brightening agent, and a storage stabilizer.

The polyethylene glycol silsesquioxane network has high anti-biofouling properties, and may therefore be widely used in medical devices which are required to be highly resistant to non-specific adsorption of biopolymers such as proteins, DNA, and cells. For example, the polyethylene glycol silsesquioxane network has a high anti-biofouling performance of 2.0% or less or 1.7% or less with respect to protein molecules in vivo. The polyethylene glycol silsesquioxane network was coated onto a transparent substrate such as glass, model biomolecules were dropped thereon and incubated for an appropriate amount of time, and then the degree of adsorption was measured in fluorescence intensity between before and after the incubation. It can be evaluated that the anti-biofouling properties were deteriorated as the amount of adsorption increased.

Moreover, the polyethylene glycol silsesquioxane network has low viscosity; high optical transparency; good hydrophilicity; high resistance to swelling in organic solvents and aqueous solutions; high stability under biological, chemical, and thermal stress, and high mechanical strength. For example, the polyethylene glycol silsesquioxane network of the present invention shows optical transparency of about 90% or more, a water contact angle of about 26.6° to about 34.7°, resistance below at 3 wt % to swelling in organic solvents and aqueous solutions, and a Young's modulus of about 1 GPa. The swelling ratio may be evaluated by dipping the polyethylene glycol silsesquioxane network in an organic solvent or aqueous solution for a predetermined period of time to make it swollen, and then measuring the difference in weight before and after the swelling.

In another aspect of the present invention, there is provided an anti-biofouling device including the polyethylene glycol silsesquioxane network.

The anti bio-fouling device including the polyethylene glycol silsesquioxane network of the present invention may be various types of biomedical devices. The anti-biofouling devices may include, but are not limited to, for example, a biomedical device, a biosensor, a diagnostic array, an implant, a drug delivery system, and a lab-on-a-chip, and may be any device so long as it requires high resistance to non-specific adsorption of biopolymers such as proteins, DNA, and cells.

In another aspect of the present invention, there is provided a method of preparing a nanopattern, the method including: forming a photocurable polyethylene glycol silsesquioxane represented by the following Formula 3 by mixing a compound represented by the following Formula 1 with a compound represented by the following Formula 2; coating a composition including the photocurable polyethylene glycol silsesquioxane and a photoinitiator onto a substrate; and irradiating UV light to the coated composition to cure and nanopattern the photocurable polyethylene glycol silsesquioxane:

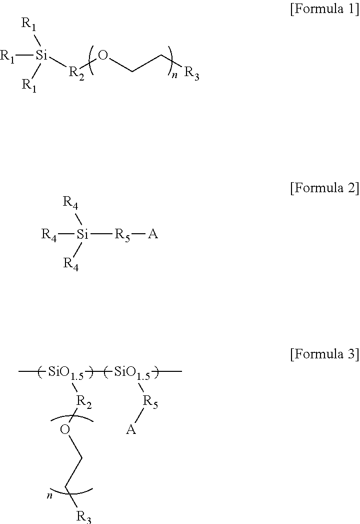

wherein,

R1 is an alkoxy group with 1 to 10 carbons, or a halogen atom;

R2 is one selected from the group consisting of a simple bond, a urethane bond, and an alkylene group with 1 to 10 carbons;

R3 is a hydroxyl group or an alkoxy group with 1 to 10 carbons;

R4 is an alkoxy group with 1 to 10 carbons, or a halogen atom;

R5 is one selected from the group consisting of a simple bond, a urethane bond, and an alkylene group with 1 to 10 carbons;

A is one photocurable functional group selected from the group consisting of an acrylate group, a methacrylate group, a glycidyl ether group, an oxetane group, an epoxy cyclohexane group, and a vinyl ether group; and

n is an integer of from 4 to 10.

A detailed description of Formulas 1, 2, and 3 is identical to those of the photocurable polyethylene glycol silsesquioxane and the polyethylene glycol silsesquioxane network.

The photoinitiator may be, but is not limited to, for example, one selected from the group consisting of DMPA (2,2′-dimethoxy-2-phenylacetophenone), HMPP (2-hydroxy-2-methyl-1-phenyl-propane-1-one), 2,4,6-trimethylbenzoyl-diphenylphosphine oxide, and diphenyl 2,4,6-trimethylbenzoyl phosphine oxide.

In accordance with one exemplary embodiment of the present invention, the nanopatterning may be performed by a method selected from the group consisting of UV nanoimprinting, UV embossing, and UV replica molding.

For example, UV replica molding may be used as the nanopatterning, which is performed, more specifically, as follows.

First of all, a composition including the photocurable polylethylene glycol silsesquioxane and a photoinitiator is coated to a transparent or opaque mold, and a transparent substrate is placed on the mold. Next, UV light is irradiated through the transparent substrate to cure the photocurable polyethylene glycol silsesquioxane, thereby preparing a nanopattern, simultaneously with the formation of a polyethylene glycol silsesquioxane network.

Alternatively, UV nanoimprinting may be used as the nanopatterning method. More specifically, a composition including the photocurable polylethylene glycol silsesquioxane and a photoinitiator is coated to a transparent substrate. Next, a transparent mold is placed on the transparent substrate, and UV light is irradiated to the mold to cure the polyethylene glycol silsesquioxane, thereby preparing a nanopattern, simultaneously with the formation of a polyethylene glycol silsesquioxane network.

The substrate may be a transparent substrate, and examples of the transparent substrate may include quartz, glass, and transparent films like PET (polyethylene terephthalate), PC (polycarbonate), and PVC (polyvinyl chloride). Before coating the composition including the polyethylene glycol silsesquioxane and the photoinitiator, primer treatment may be conducted on the substrate in order to give adhesion properties.

In accordance with the preparation method of the present invention, a fine nanopattern may be formed to have a size of 25 nm or less, for example, a size of about 25 nm, a half-pitch of 25 nm, and a height of 100 nm.

The method of preparing a nanopattern in accordance with the present invention may be applied in the manufacture of various types of anti-biofouling devices. The anti-biofouling devices may include, but are not limited to, for example, a biomedical device, a biosensor, a diagnostic array, an implant, a drug delivery system, and a lab-on-a-chip, and may be any device so long as it requires high resistance to non-specific adsorption of biopolymers such as proteins, DNA, and cells.

Hereinafter, the present invention will be described more fully with examples. These examples are only illustrative of the present invention, and it should be clear to anyone skilled in the art that these should not be construed as limiting the scope of the invention

### Examples

### Example

### Preparation of Photocurable Polyethylene Glycol Silsesquioxane

A mixture obtained by dissolving 7 g of 3-(acryloyloxy)propyl trimethoxysilane and 3 g of polyethylene glycol trimethoxysilane in 20 ml of ethanol was prepared, and then, while strongly stirring the mixture, 600 mg of distilled water containing 4 mg of KOH was slowly injected drop by drop into the mixture.

After stirring the mixture for 12 hours at 25° C., the temperature was raised to 105° C. to heat the mixture for 1 hour, then the temperature was dropped to room temperature, and then 10 g of distilled water as added to the mixture for dilution. Additionally, acetic acid was added to the mixture for neutralization, and then the mixture was washed with distilled water several times.

After the washing, volatile matters were removed by a rotator evaporator, thereby obtaining a light yellow liquid of photocurable polyethylene glycol silsesquioxane (viscosity: about 420 oP, yield: about 85%)

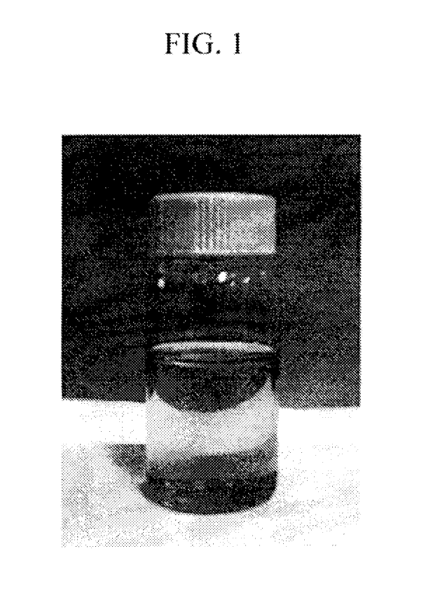

FIG. 1 is a photograph of a polyethylene glycol silsesquioxane obtained is in accordance with Example 1.

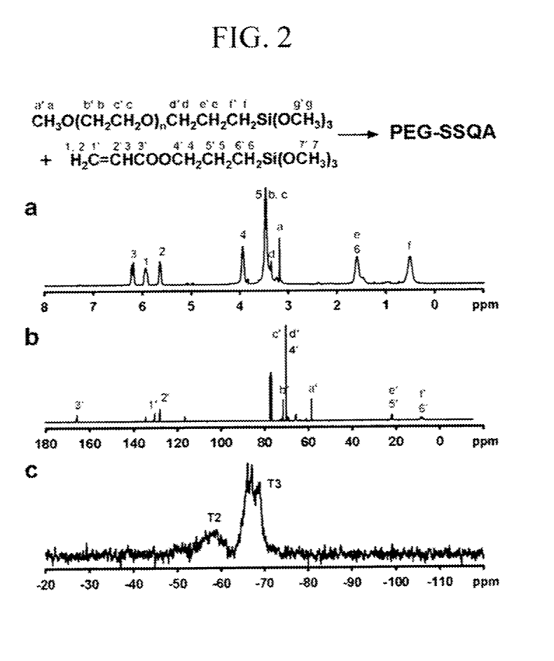

FIG. 2 shows NMR spectra of the polyethylene glycol silsesquioxane obtained in accordance with Example 1. FIG. 2 shows ¹H- and ¹³C-NMR spectra of polyethylene glycol silsesquioxane in CDCl₃ and a ²⁹Si-NMR spectrum of polylethylene glycol silsesquioxane in C₆D₆ which were measured on a Bruker DMX600.

### Example 2

### Preparation of Polyethylene Glycol Silsesquioxane

About 3 wt % of an UV initiator (Darocur 1173) was added to the polylethylene glycol silsesquioxane of Example 1, and then cured by an 80-W mercury short arc lamp (INNO-CURE 100N; Lichtzen Co., Ltd.), thereby obtaining a polyethylene glycol silsesquioxane network.

### Example 3

### Preparation of Nanopattern

A composition was prepared by adding about 3 wt % of an UV initiator (Darocur 1173) to the polyethylene glycol silsesquioxane of Example 1, and then about 1 μl of the composition was dispensed drop by drop on a silicon master mold modified with PFOS (trichloro(1H,1H,2H,2H-perfluorooctyl)silane) (Sigma Aldrich) as a mold release agent. The silicon master mold used was NIM25L/100 having a size of 25 nm, a line width ratio of 1.1, and a height of 100 nm, purchased from NTT-AT Corporation. A transparent base material of a PET film was transferred onto the surface, and the transparent base material was irradiated with UV light for 2 minutes to 3 hours while being compressed at a pressure of 0.1 MPa for 10 seconds under a vacuum condition to cure the polyethylene glycol silsesquioxane, and then the mold was removed from the substrate.

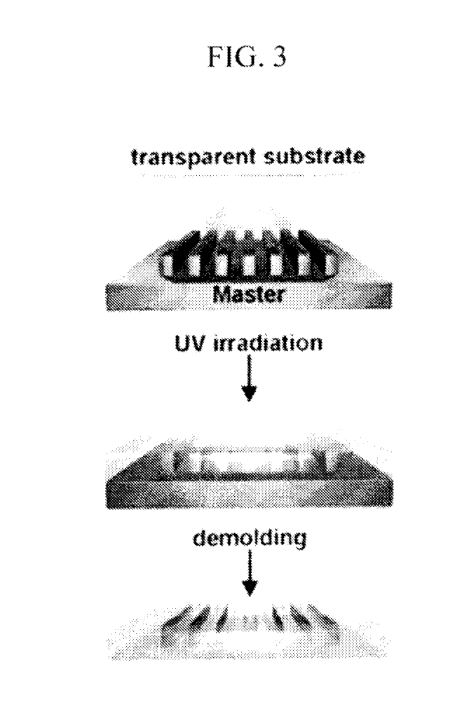

A schematic view of a method of preparing the nanopattern is depicted in FIG. 3.

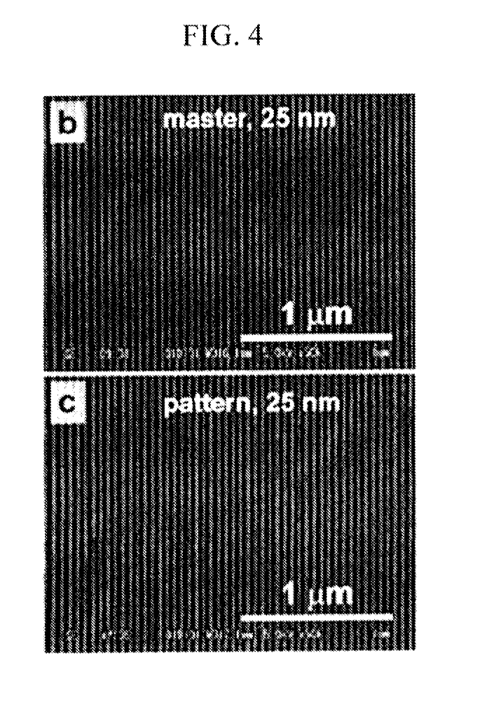

A scanning electron micrograph of the nanopattern prepared by the above method is depicted in FIG. 4. In FIG. 4, the upper part shows a photograph of the master mold, and the lower part shows a photograph of the nanopattern.

Referring to FIG. 4, it can be seen that a good nanopattern with no defects was prepared from a master mold having a half-pitch of 25 nm, a line width ratio of 1:1, and a height of 100 nm.

### Experimental Example

### Experimental Example 1

### Viscosity Measurement

The viscosity of a composition containing the polyethylene glycol silsesquioxane of Example 1 and 2 wt % of a photoinitiator (Darocur 1173) was measured on a Brookfield viscometer. The viscosity of PEG-SSQA, measured at 25° C., was 420 CP.

### Experimental Example 2

### Water contact Angle Measurement

The water contact angle of the polyethylene glycol silsesquioxane network of Example 2 was measured by a contact angle analyzer (Mouse-X; SurfaceTech Co., Ltd.).

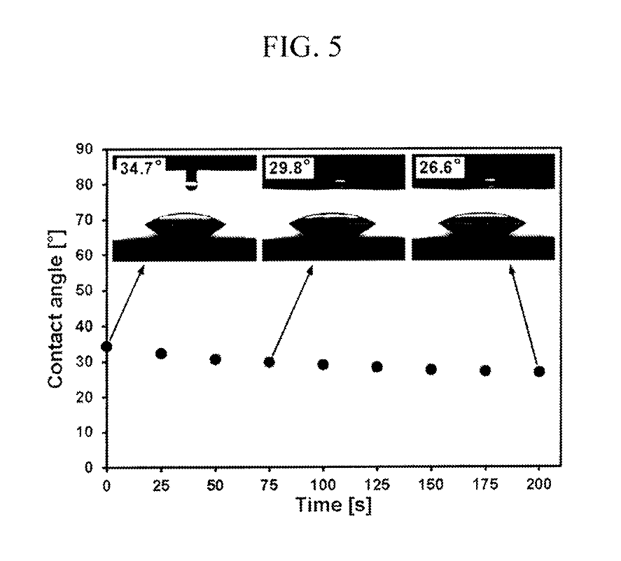

FIG. 5 is a graph showing changes in contact angle over time. The images incorporated in FIG. 5 are photographs of droplets of the surface of the polyethylene glycol silsesquioxane network.

Referring to FIG. 5, the polyethylene glycol silsesquioxane network shows a low contact angle ranging from 26.6° to 34.7°. This means that the polyethylene glycol silsesquioxane network has high hydrophilicity, which is desirable to avoid non-specific adsorption of biopolymers.

### Experimental Example 3

### Swelling Measurement

The polyethylene glycol silsesquioxane network of Example 2 was dipped in water and toluene, respectively, for 48 hours. The swelling ratio (Qᵣ) of the swollen polyethylene glycol silsesquioxane network was measured, and the results are shown in the following Table 1,

Swelling Ratio (Qᵣ)=100*(Wₛ−W_{d})/W_{d}%

(Wₛ: weight of polyethylene glycol silsesquioxane network swollen in each solvent for 48 hours, W_{d}: weight of polyethylene glycol silsesquioxane network dried for 48 hours in a vacuum desiccator)

TABLE 1

| | Swelling Ratio (Qᵣ) |
|---|---|
| Solvent | [unit:wt %] |
| Water | <1.8 |
| Toluene | <3 |

Referring to Table 1, it was observed that the polyethylene glycol silsesquioxane network in accordance with the present invention exhibited quite low swelling ratios of 1.8 wt % and 3 wt % in water and toluene, respectively. These results suggest that the polyethylene glycol silsesquioxane network of the present invention is stable in water and organic solvents.

### Experimental Example 4

### Optical Transparency

The transmittance of the polyethylene glycol silsesquioxane network of Example 2 was measured.

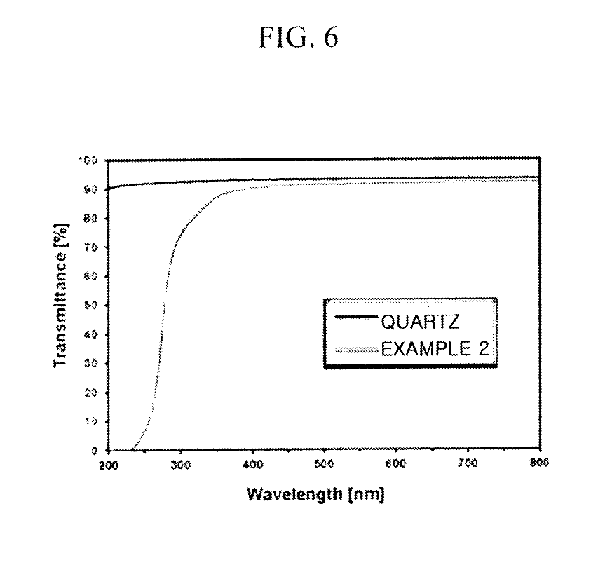

FIG. 6 is a graph showing the transmittance versus wavelength of the polyethylene glycol silsesquioxane network and quartz.

Referring to FIG. 6, it can be seen that the polyethylene glycol silsesquioxane network of the present invention has transmittance of 90% or more with respect to a wavelength of 365 nm or more.

### Experimental Example 5

### Young's Modulus

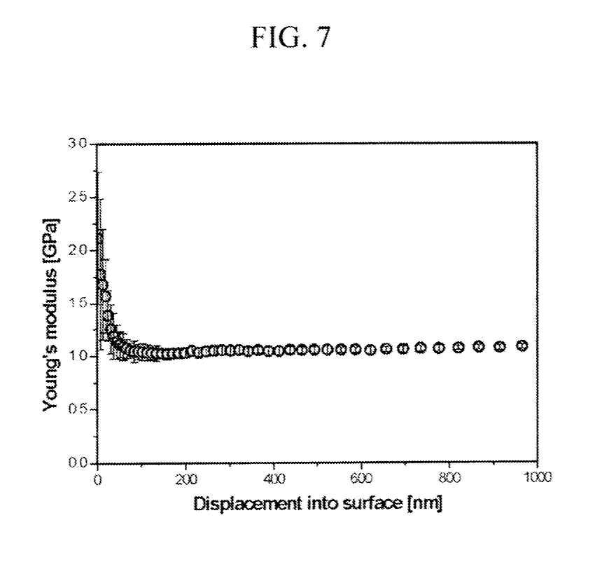

The Young's modulus of the polyethylene glycol silsesquioxane of Example 2 was measured by nanoindentation, and the result is shown in FIG. 7.

Referring to FIG. 7, the minimum Young's modulus at a contact depth from 30 nm to 200 nm was determined to be about 1 GPa.

### Experimental Example 6

### Shrinkage Percentage

The shrinkage percentage of the polyethylene glycol silsesquioxane network nanopattern prepared in Example 3 was measured based on the difference in height with the mold.

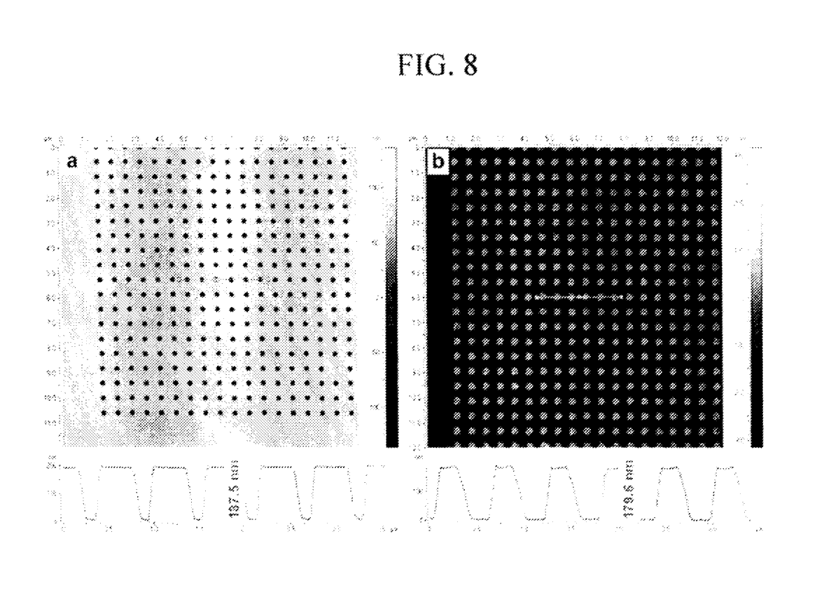

FIG. 8 shows atomic force microscope (AFM) images of a polyethylene glycol silsesquioxane network pattern and a mold.

Referring to FIG. 8, the shrinkage percentage of the polyethylene glycol silsesquioxane network pattern was measured to be 4.2% or less. This suggests that such a low shrinkage percentage enables the manufacture of a precise nanopattern.

### Experimental Example 7

### Anti-Biofouling Properties

To confirm that a polyethylene glycol silsesquioxane network prevents non-specific adsorption of biomolecules, the polyethylene glycol silsesquioxane network of Example 2 was applied on a glass substrate.

The adsorption of biomolecules was measured using a fluorescence method. To this end, EGFP (enhanced green fluorescence protein) and BSA-FITC (fluorescein isothiocyanate-labeled bovine serum albumin) were used as model biomolecules.

EGFP and BSA-FITC were respectively dissolved at 3 mM in 10 mM PBS (pH 7.4), and these solutions were dripped onto glass and the polyethylene glycol silsesquioxane network of Example 2, incubated for 1 hour at room temperature, and washed with PBS, thereby acquiring fluorescence images of the substrates. Green emissions of 480-550 nm were filtered using a U-MSWG Olympus filter cube

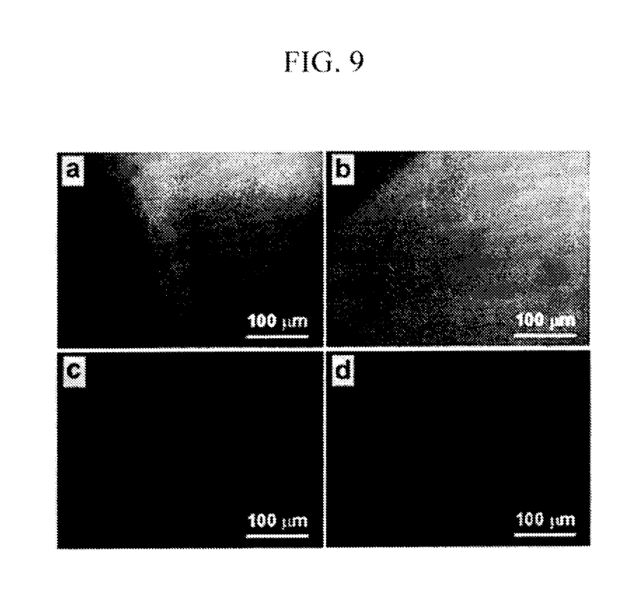

FIG. 9 is a photograph showing fluorescence images of glass and the polyethylene glycol silsesquioxane network of Example 2. In FIG. 9, the left upper image (a) is a fluorescence image of EGFP dropped onto glass, the right upper image (b) is a fluorescence image of BSA-FITC dripped on glass, the left lower image (c) is a fluorescence image of eGFP dripped onto the polyethylene glycol silsesquioxane network, and the right lower image (d) is a fluorescence image of BSA-FITC dripped onto the polyethylene glycol silsesquioxane network.

Referring to FIG. 9, it can be seen that the polyethylene glycol silsesquioxane network of Example 2 strongly restricts non-specific adsorption of proteins compared with the glass substrate.

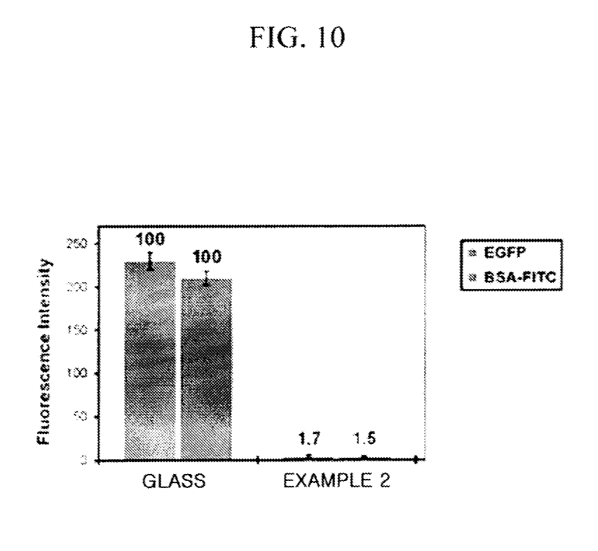

To quantitatively measure the amount of adsorption of proteins on each surface, protein (BSA-FITC, EGFP) solutions were dripped onto glass and the polyethylene glycol silsesquioxane network of Example 2, incubated for 1 hour at room temperature, and washed with PBS. Fluorescence images of the substrates were acquired, as shown in FIG. 10, with an Olympus BX51 inverted research microscope equipped with a fluorescence attachment (IX-FLA; Olympus) and a high-resolution digital camera (DP70; Olympus). Green emissions of 480-550 nm were filtered using a U-MSWG Olympus filter cube.

Referring to FIG. 10, it can be seen that the polyethylene glycol silsesquioxane network of Example 2 showed 1.6% adsorption of EGFP and 1.5% adsorption of BSA-FITC, compared with the glass substrate set to 100 $ adsorption.

Accordingly, the SSQ/PEG networks having high optical transparency, low viscosity, anti-swelling property, hydrophilicity, high mechanical strength, and high stability under chemical, thermal, and biological stress are capable of free radical copolymerization and direct nanopatterning. From this viewpoint, these networks can be used in a wide range of biomedical applications including a nano-biodevice, a nano-biosensor, and a lab-on-a-chip.

The polyethylene glycol silsesquioxane network in accordance with the present invention has a high anti-biofouling property, low viscosity, high optical transparency, good hydrophilicity, high resistance to swelling in organic solvents/aqueous solutions, high stability under biological, chemical, and thermal stress, and high mechanical strength, and can be useful in a wide range of biomedical devices because it enables the manufacture of micro-nanopatterns.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A photocurable polyethylene glycol silsesquioxane (PEG-SSQA) represented by the following Formula 3: 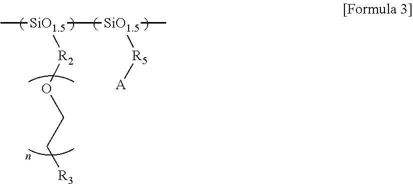
wherein,
R2 is one selected from the group consisting of a simple bond, a urethane bond, and an alkylene group with 1 to 10 carbons;
R3 is a hydroxyl group or an alkoxy group with 1 to 10 carbons:
R5 is one selected from the group consisting of a simple bond, a urethane bond, and an alkylene group with 1 to 10 carbons;
A is one photocurable functional group selected from the group consisting of an acrylate group, a methacrylate group, a glycidyi ether group, an oxetane group, an epoxy cyclohexane group, and a vinyl ether group; and
n is an integer of from 4 to 10.

2. The photocurable polyethylene glycol silsesquioxane of claim 1, which is prepared by hydrolytic condensation of a compound represented by the following Formula 1 and a compound represented by the following Formula 2: 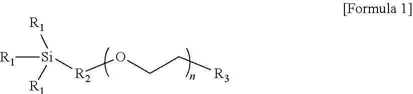
wherein,
R1 is an alkoxy group with 1 to 10 carbons or a halogen atom; R2 is one selected from the group consisting of a simple bond, a urethane bond, and an alkylene group with 1 to 10 carbons; R3 is a hydroxyl group or an alkoxy group with 1 to 10 carbons; and
n is an integer of from 4 to 10, 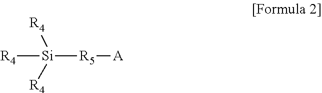
wherein,
R4 is an alkoxy group with 1 to 10 carbons or an halogen atom; R5 is one selected from the group consisting of a simple bond, a urethane bond, and an alkylene group with 1 to 10 carbons; and A is one photocurable functional group selected from the group consisting of an acrylate group, a methacrylate group, a glycidyl ether group, an oxetane group, an epoxy cyclohexane group, and a vinyl ether group.

3. The photocurable polyethylene glycol silsesquioxane of claim 1, wherein, in the Formula 3, R2 is an alkylene group with 1 to 6 carbons, R3 is an alkoxy group with 1 to 3 carbons, R5 is an alkylene group with 1 to 6 carbons, and A is an acrylate group.

4. The photocurable polyethylene glycol silsesquioxane of claim 2, wherein, in the Formula 1, R1 is an alkoxy group with 1 to 3 carbons, R2 is an alkylene group with 1 to 6 carbons, and R3 is an alkoxy group with 1 to 3 carbons, and in the Formula 2, R4 is an alkoxy group with 1 to 3 carbons, R5 is an alkylene group with 1 to 6 carbons, and A is an acrylate group.

5. A polyethylene glycol silsesquioxane network which is prepared by mixing a photoinitiator with the photocurable polyethylene glycol silsesquioxane according to claim 1 and curing the mixture by UV irradiation.

6. The polyethylene glycol silsesquioxane network of claim 5, which has high anti-biofouling performance of 2.0% or less or 1.7% or less with respect to protein molecules in viva.

7. An anti-biofouling device comprising the polyethylene glycol silsesquioxane network of claim 5.

8. The anti-biofouling device of claim 7, which is selected from the group consisting of a biomedical device, a biosensor, a diagnostic array, an implant, a drug delivery system, and a lab-on-a-chip.

9. A method of preparing a nanopattern, the method comprising:
forming a photocurable polyethylene glycol silsesquioxane represented by the following Formula 3 by mixing a compound represented by the following Formula 1 with a compound represented by the following Formula 2;
coating a composition including the photocurable polyethylene glycol silsesquioxane and a photoinitiator onto a substrate; and
irradiating UV light to the coated composition to cure and nanopattern the photocurable polyethylene glycol silsesquioxane: 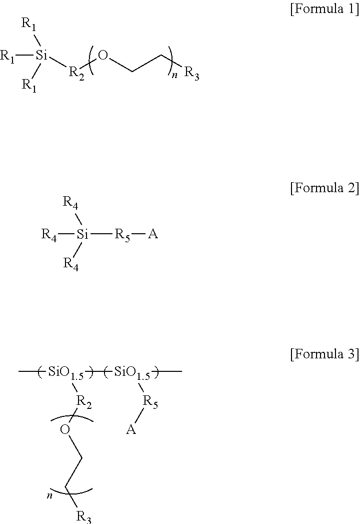
wherein,
R1 is an alkoxy group with 1 to 10 carbons or a halogen atom;
R2 is one selected from the group consisting of a simple bond, a urethane bond, and an alkylene group with 1 to 10 carbons;
R3 is a hydroxyl group or an alkoxy group with 1 to 10 carbons;
R4 is an alkoxy group with 1 to 10 carbons or a halogen atom;
R5 is one selected from the group consisting of a simple bond, a urethane bond, and an alkylene group with 1 to 10 carbons;
A is one photocurable functional group selected from the group consisting of an acrylate group, a methacrylate group, a glycidyl ether group, an oxetane group, an epoxy cyclohexane group, and a vinyl ether group; and
n is an integer of from 4 to 10.

10. The method of claim 9, wherein the nanopatterning is performed by a method selected from the group consisting of UV nanoimprinting, UV embossing, and UV replica molding.

11. The method of claim 9, wherein the photoinitiator is one selected from the group consisting of DMPA (2,2′-dimethoxy-2-phenylacetophenone), HMPP (2-hydroxy-2-methyl-1-phenyl-propane-1-one), 2,4,6-trimethylbenzoyl-diphenylphosphine oxide, and diphenyl 2,4,6-trimethylbenzoyl phosphine oxide.

12. The method of claim 8, wherein the nanopattern has half-pitch of 25 nm or less.
